(19) United States
(12) Patent Application Publication
(10) Pub. No.: US 2006/0087194 A1
(43) Pub. Date: Apr. 27, 2006

(54) Motor using rectangular waveform conductor

(76) Inventor: Mitsuhiro Kataoka, Hiroshima (JP)

Correspondence Address: BACON & THOMAS, PLLC, 625 SLATERS LANE, FOURTH FLOOR, ALEXANDRIA, VA, 22314, US

(21) Appl. No.: 10/540,269

(22) PCT Filed: Mar. 10, 2005
(86) PCT No.: PCT/JP05/04716

§ 371 Date: Jun. 23, 2005

(30) Foreign Application Priority Data
Mar. 12, 2004 (JP) 2004-069976
May 19, 2004 (JP) 2004-148992

(51) Int. Cl. H02K 41/00; H02K 21/12; H02K 21/00

(52) U.S. Cl. 310/207; 310/268; 310/12; 310/156.39

(57) ABSTRACT

To provide a compact, light and simple linear or rotary motor driven by direct-current electric power at a low manufacturing cost for use of house fittings, carrying devices, electronic devices, and home electric appliances, a linear magnetic pole row (2) or an annular magnetic pole row (4) in which N and S poles are alternately arranged is structured with permanent magnets as a movable side electromagnetic member, two sets of coreless-type rectangular wave wires are provided as a fixed side electromagnetic member, every time when the magnetic pole row moves by one half pitch, the electricity application is switched from one of the two sets of wave wires to the other.

### TECHNICAL FIELD

The present invention relates to a motor which is improved in such a manner that an electric current is not necessary to be sent through a movable member and a manufacturing cost can be reduced on the basis of a smaller size and a reduced weight of a fixed member, and can be applied to both a rotary motor and a linear motor.

### BACKGROUND ART

In conventional, a motor has been generally structured such as to be driven by a magnetic attraction and a magnetic repulsive force between a fixed side electromagnet and a movable side electromagnet.

In the case that the movable side electromagnet is rotatably supported, and an electromagnetic driving force is applied in a circular arc direction (or a tangential direction), the rotary motor is structured.

In the case that the movable side electromagnetic force is guided along a straight line, and the electromagnetic driving force is applied in a guiding direction, the linear motor is structured.

### DISCLOSURE OF THE INVENTION

### Problem of Prior Art

Since the motor in accordance with the prior art is structured on the basis of the magnetic force application between the electromagnets whichever the motor is of the linear type and of the rotary type, an iron core of the electromagnet has a heavy weight, the entire of the motor apparatus is large in size and heavy in weight, and a manufacturing cost is high.

In addition, an electricity conducting structure for sending an electric current to the movable side electromagnet is required, and an alternating-current power supply is required for executing an electromagnetic induction operation.

### Object of the Presnt Invention

The present invention is made by taking the matters mentioned above into consideration, and an object of the present invention is to provide a linear motor which has a compact size, a reduced weight and a low cost, and can be driven by a direct-current power supply, and a rotary motor which has a compact size, a reduced weight and a low cost, and can be driven by a direct-current power supply.

<Means for Achieving Object>

A description will be briefly given of a basic principle of the present invention created for achieving the object mentioned above with reference to FIG. 1 as follows.

FIG. 1 shows an example structured as a linear motor moving a sliding door 1.

An axis X corresponds to an operating direction of the sliding door, an axis Y corresponds to a thickness direction of the sliding door, and an axis Z corresponds to a vertical direction.

A lot of magnet poles N and S are arranged alternately so as to form a linear magnetic pole row 2.

A rectangular wave wire 3 is arranged in parallel to a plane X-Y, in a direction of the axis X, and with a pitch in correspondence to a magnetic pole arrangement pitch of the linear magnetic pole row, and the rectangular wave wire is placed in a fixed member (for example, a door lintel).

When sending an electric current through the rectangular wire 3 mentioned above as shown by an arrow E-E′, currents i and j flow in a direction of the axis Y, and the rectangular wave wire 3 receives a force in a direction of an arrow f on the basis of an electromagnetic effect.

However, since the rectangular wave wire is a fixed member and is not moved, the linear magnetic pole row 2 attached to the sliding door 1 corresponding to a movable member is driven in a direction of an arrow F on the basis of a reaction thereof.

The description given above with reference to FIG. 1 is an operating principle of a linear motor in accordance with the present invention.

As is apparent from the structure and function mentioned above, the portion in the direction of the axis Y is important for generating the driving force, in the rectangular wave wire 3. This portion in the direction of the axis Y is called as an element of the rectangular wave wire.

A rotary motor structured by applying the same principle is shown in FIG. 2. Reference symbol Z denotes a vertical axis, and reference symbol H denotes a horizontal plane.

An annular magnetic pole row 4 is formed by arranging a lot of magnetic poles N and S alternately along the plane H in a circular shape around the axis Z.

An element denoted by reference numeral 4 is an annular magnetic pole row corresponding to the linear magnetic pole row 2 mentioned above (FIG. 1).

An element denoted by reference numeral 5 is a rectangular wave coil corresponding to the rectangular wave lead wire 3 mentioned above (FIG. 1). When sending an electric current through the rectangular wave coil 5 as shown by arrows a, b, c . . . h, the annular magnetic pole row 4 is rotated as shown by an arrow F′.

The description given above with reference to FIG. 2 is an operating principle of a rotary motor in accordance with the present invention.

As is apparent from the structure and function mentioned above, the radial portion around the axis Z is important for generating the driving force, in the rectangular wave coil 5. This radial portion is called as an element of the rectangular wave coil.

The principle for generating the driving force in accordance with the present invention is as mentioned with reference to FIGS. 1 and 2, however, the movable member is moved by only one pitch distance of the magnetic pole arrangement in accordance with the structure.

A description will be given next of a reason why the movable member is moved by only one pitch and is stopped, and of a structure for continuously moving.

FIG. 3A is a plan view drawing the same structure portion as that in FIG. 1 mentioned above (in which an illustration of the sliding door 1 is omitted). As a matter of convenience for explanation, the rectangular wave wire is drawn by a broken line and is denoted by reference symbol 3A. When sending an electric current through the rectangular wave wire as shown by arrows, the linear magnetic pole row 2 is moved to a right side in the drawing.

When the linear magnetic pole row 2 is moved to a right side by a half pitch (p/2), a relation between the rectangular wave wire 3A (the broken line) and the linear magnetic pole row 2 becomes as shown by FIG. 3B. As mentioned above, when the element of the rectangular wave wire coincides with a boundary line of the magnetic pole, the force in the direction of the axis X is not applied.

Therefore, a rectangular wave wire 3B drawn by a solid line is previously provided.

Reference symbol 3A denotes a first phase rectangular wave wire, and reference symbol 3B denotes a second phase rectangular wave wire. Both the elements are shifted by a half pitch (p/2) in the direction of the axis X.

(1) When the linear magnetic pole row 2 is moved by the distance p/2 by sending an electric current through the first phase rectangular wave wire 3A and the driving force is then lost, the electric current application is switched to the second phase rectangular wave wire 3B.

(2) When the linear magnetic pole row 2 is moved by the distance p/2 by sending an electric current through the second phase rectangular wave wire 3B, the electric current application is again switched to the first phase rectangular wave wire 3A. In this case, the electric current is sent in an opposite direction to that in the item (1) mentioned above (because polarities of the opposing magnetic poles are counterchanged).

(3) When the linear magnetic pole row 2 is moved by the distance p/2 in accordance with the item (2), the sending of an electric current is switched to the second phase rectangular wave wire 3B. One cycle is finished thereby.

In order to switch the electric current application in the manner mentioned above, it is necessary to detect the movement of the linear magnetic pole row 2.

A measure is attached to the linear magnetic pole row 2 fixed to the sliding door, and a circuit changing switch (not shown) is activated by reading a motion of the measure by means of an optical sensor 8.

A description will be in detail given later of an attaching position of the measure 7 and the optical sensor 8 with reference to FIG. 6.

While the structure for continuously operating the linear motor is as mentioned above with reference to FIG. 3, a description will be given below of a case of the rotary motor.

When the element of the rectangular wave coil faces to the magnetic pole as shown in FIG. 4A, the annular magnetic pole row 4 is rotated in the direction of the arrow F′ by sending an electric current in accordance with the arrows a, b, . . . h. However, when the element of the rectangular wave coil faces to the boundary line of the magnetic poles as shown in FIG. 4B, a rotation driving force disappears. Accordingly, the structure is previously made as follows.

FIG. 5B is a detailed view of the rectangular wave coil 5. The rectangular wave coil 5 is structured by arranging a first phase rectangular wave coil 5A and a second phase rectangular wave coil 5B so as to be shifted by a half of an angular pitch of rotation. Further, the electric current application is switched per the rotation of a half angular pitch (p/2).

FIG. 5A is a plan view of the annular magnetic pole row 4. Facing to the magnetic pole, two Hall sensors 18 are arranged so as to be shifted by one fourth of the angular pitch p (in detail, by odd number times of p/4). The electric current application is switched between the first phase rectangular wave coil 5A and the second phase rectangular wave coil 5B by an electric current changing switch (not shown), on the basis of a signal detected by the Hall sensor 18.

Since the switching of electric current application in the rotary motor is the same in principle as that of the linear motor, a detailed description will be omitted.

### BRIEF DESCRIPTION OF THE DRAWINGS

FIG. 1 is a schematic perspective view for explaining a working principle of a linear motor structured by applying the present invention;

FIG. 2 is a schematic perspective view for explaining a working principle of a rotary motor structured by applying the present invention;

FIGS. 3A and 3B are views drawing a structure for continuously actuating the linear motor;

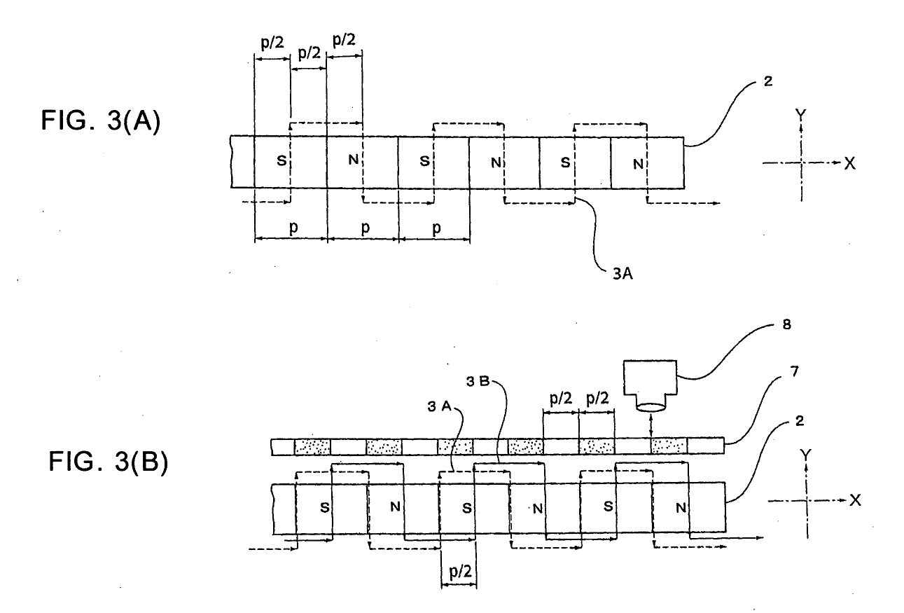

FIGS. 4A and 4B are schematic perspective views for explaining a driving force generated in the rotary motor;

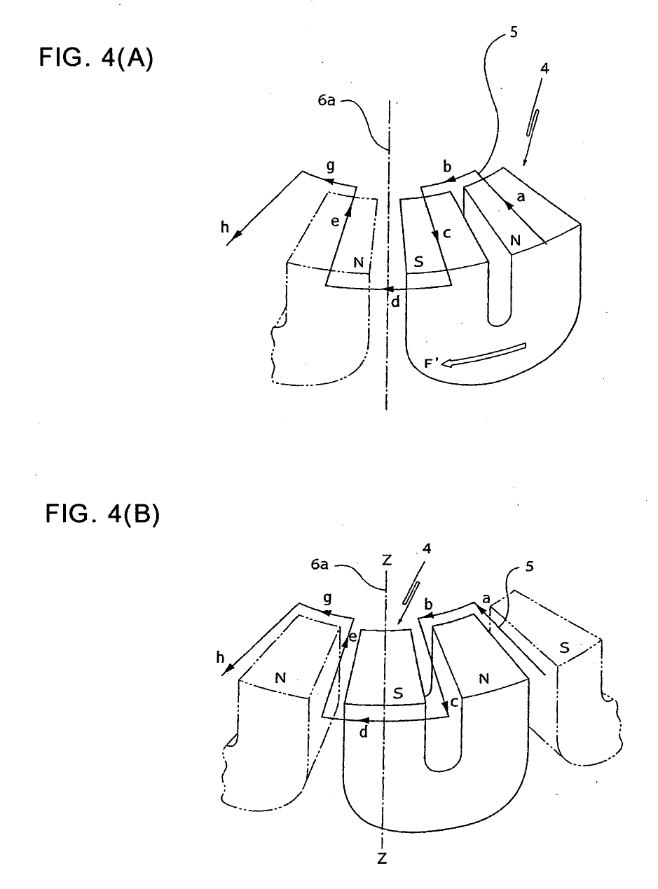

FIGS. 5A and 5B are views drawing a structure for continuously actuating the rotary motor;

FIG. 6 is a cross sectional view drawing an embodiment of the linear motor in accordance with the present invention; and

FIG. 7 is a cross sectional view drawing an embodiment of the rotary motor in accordance with the present invention.

### BEST MODE FOR CARRYING OUT THE INVENTION

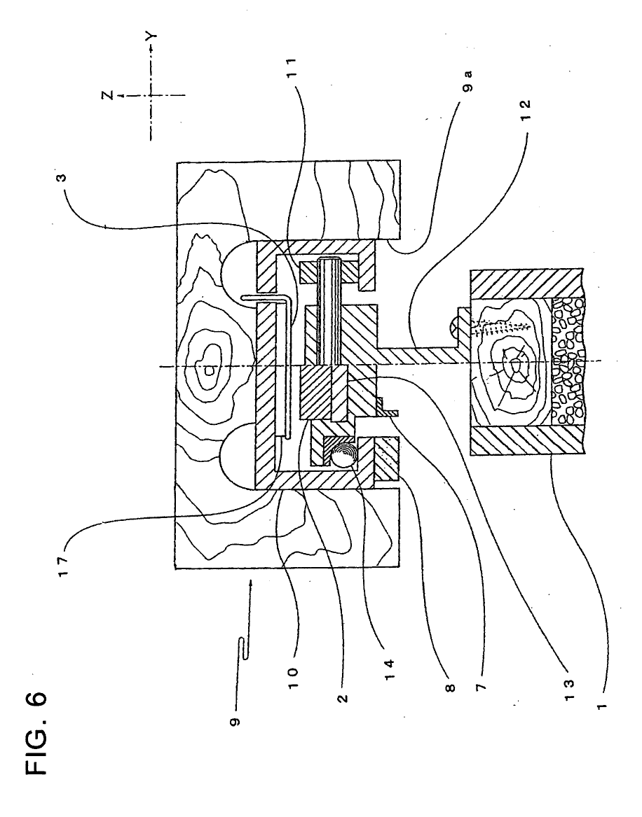

FIG. 6 is a vertical cross sectional view drawing an embodiment in which the present invention is applied to a sliding door.

An axis X corresponding to a moving direction of a sliding door 1 is perpendicular to a paper surface.

A groove 9a in a direction of the axis X is formed in a door lintel 9, and a rail-cum-case 10 is fitted to the groove.

The rail-cum-case mentioned above has an angular C-shaped cross section. In the present embodiment, a commercially available rail (a sliding door rail similar to a curtain rail) is employed.

A roller 11 is attached to the sliding door 1 via a support device 12, and travels on a rail surface of the rail-cum-case.

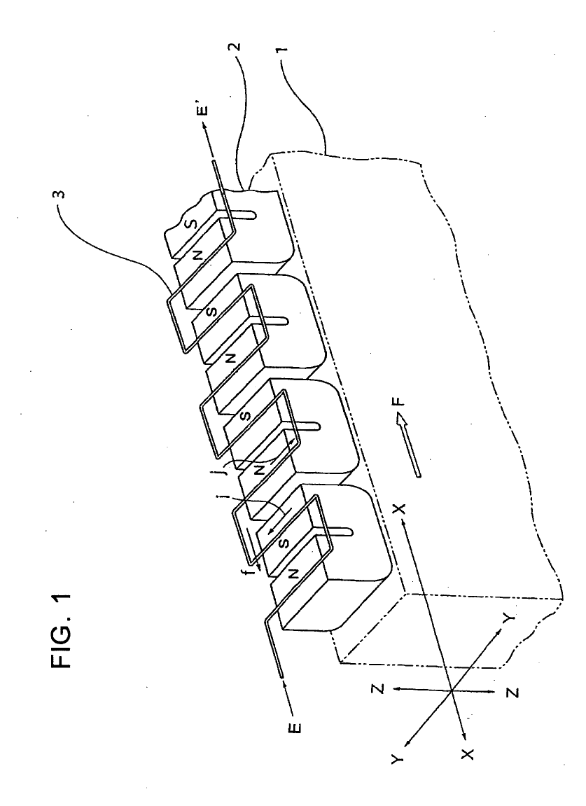

A rectangular wave wire 3 (a member shown in FIG. 1 mentioned above) is attached to a ceiling surface of the rail-cum-case 10 mentioned above. Reference numeral 17 denotes a magnetic guide plate.

Since the rectangular wave wire 3 is a compact and light (particularly thin) member, the rectangular wave wire 3 can be conveniently received in the sliding door rail which is usually available in the market.

A linear magnetic pole row 2 in the direction of the axis X is attached to the support device 12, and faces to the rectangular wave wire 3. The linear magnetic pole row 2 corresponds to the member shown in FIG. 1 mentioned above, however, is structured by magnetizing an elongated magnet steel plate, in the embodiment in FIG. 6. Reference numeral 13 denotes a back plate. The back plate can double as the magnetic guide plate.

A gravity load of the sliding door 1 is supported by the roller 11. The sliding door is positioned and borne in the direction of the axis Y by a guide ball 14.

An optical sensor 8 is placed in the rail-cum-case 10, and a measure 7 is attached to the support device 12.

Since it is not necessary to connect an electric wire to the measure, the measure has no difficulty with regard to wiring even if the measure is attached to the movable member side (the sliding door 1).

Although an illustration is omitted, a switch circuit is connected to the optical sensor 8 via a signal line, thereby an electric current application of the rectangular wave wire 3 is switched.

If an assembly part is structured by removing the door lintel 9 and the sliding door 1 from the members drawn in FIG. 6, and adding the electric control member, a market circulating property is provided, and it is possible to greatly contribute to development of a house building industry.

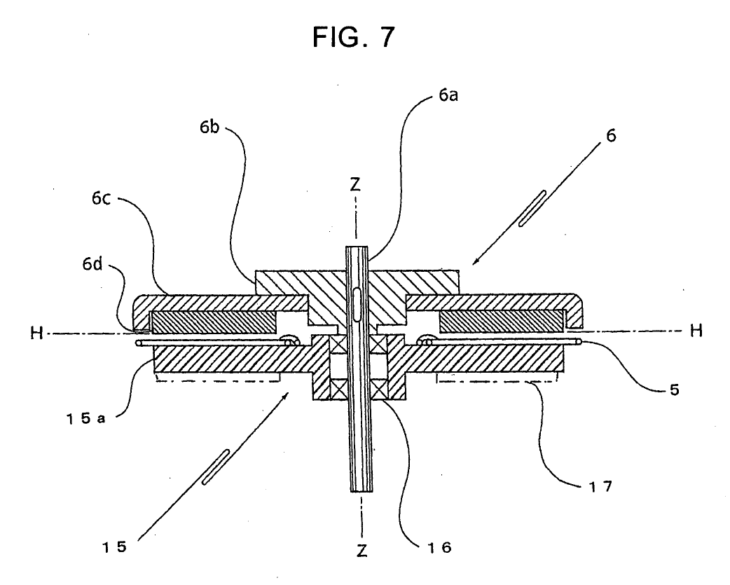

FIG. 7 is a vertical cross sectional view drawing an embodiment of a rotary motor 1 structured by applying the present invention.

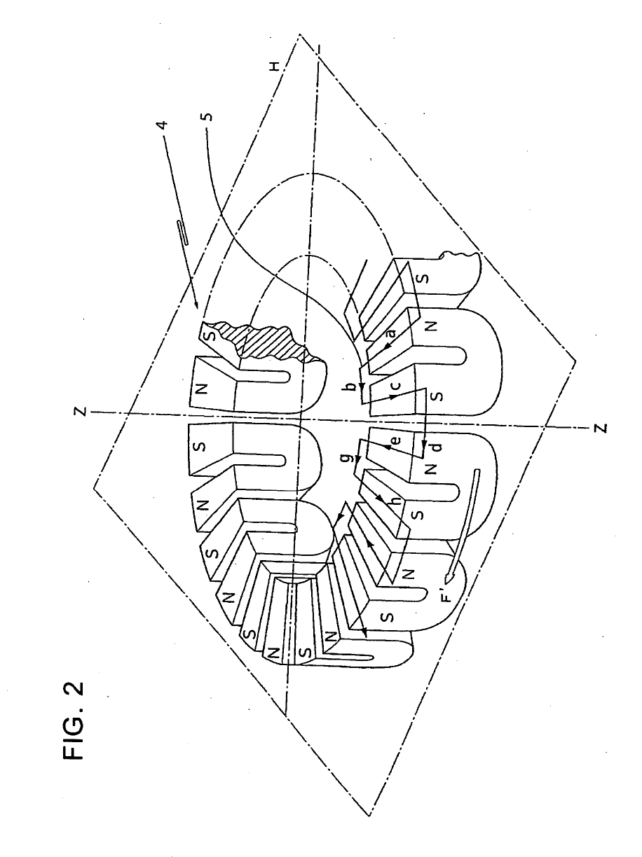

Illustrated reference symbols H and Z are added for conveniently comparing with FIG. 2 corresponding to the schematic principle view. A rotary shaft 6a is arranged concentrically with the axis Z.

A rotor 6 is supported by the rotary shaft 6a.

The rotor 6 is structured such that a ring-like steel plate 6c is supported by a hub 6b, an annular magnetized steel plate 6d is attached to the ring-like steel plate, and a magnetic pole surface (a lower surface in the drawing) of the ring-like magnetized steel plate is in parallel to a plane H.

On the other hand, the rotary shaft 6a is rotatably supported to a stator 15 by a bearing 16.

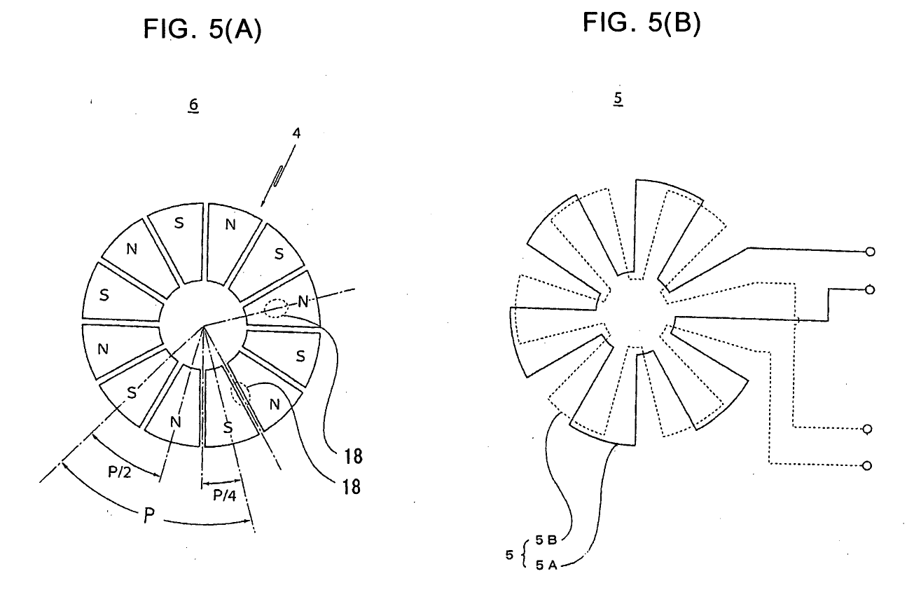

The stator 15 is structured such that a rectangular wave coil 5 (a member shown in FIGS. 2 and 5B) is attached to a disc-like resin plate 15a.

In the case of carrying out the present invention, the disc-like resin plate is not necessarily made of a resin literally, however, it is desirable that the disc-like resin plate is structured by an electric insulative material for preventing a Lenz loss.

A magnetic guide plate 17 shown by a broken line may be provided at a position facing to the rectangular wave coil 5 below the disc-like resin plate 15a. The provision of the magnetic guide plate has an advantage and a disadvantage, that is, a magnetic guide resistance is reduced and Fleming force is increased, but on the contrary, a magnetic attraction force is applied between the annular magnetized steel plate 6d and the magnetic guide plate 17 and a thrust force is applied to the bearing 16.

### INDUSTRIAL APPLICABILITY

The motor in accordance with this invention can be widely utilized in the house building industry or the like, and can be utilized in the field of the linear motor or the like.

1. A motor using a rectangular wave wire, in an apparatus of electrically opening and closing a sliding door, comprising:
a linear magnetic pole row (2) in which N poles and S poles are alternately arranged at a fixed pitch (p), the linear magnetic pole row being placed in an upper end portion of the sliding door;
two sets of rectangular wave wires (3A, 3B) in which elements in a direction of an axis Y are arranged in a direction of an axis X at the fixed pitch (p), the rectangular wave wires being fixed to a building so as to face to said linear magnetic pole row (2); and
a means for sending an electric current through said two sets of rectangular wave wires (3A, 3B),
three axes X, Y and Z being orthogonal to each other, the axis X being set in a direction of an opening and closing movement of said sliding door, and the axis Z being approximately vertical,
wherein said two sets of rectangular wave wires (3A, 3B) are shifted by a half pitch (p/2) from each other in the direction of the axis X, and said means for sending an electric current has a function of alternately switching the electric current application of any one set of rectangular wave wire to the other set of rectangular wave wire, every time when the linear magnetic pole row (2) fixed to said sliding door moves by one half pitch (p.2).

2. A motor using a rectangular wave wire as claimed in claim 1, wherein said means for sending an electric current is provided with a measure (7) which is arranged in the direction of the axis X and attached to the sliding door, and an optical sensor (8) which reads a moving distance of said measure and is attached to the building, and said optical sensor has a function of outputting a detected signal every time when said measure moves by one half pitch (p/2).

3. A motor using a rectangular wave wire as claimed in claim 1, wherein a rail-cum-case (10) having an angular C-shaped cross section, and having a shape schematically similar to a curtain rail is provided to the motor, said rectangular wave wire (3) is attached to an inner surface of said rail-cum-case, and said linear magnetic pole row (2) can pass through a space within said rail-cum-case in the direction of the axis X.

4. A motor using a rectangular wave wire, comprising:
a rotary shaft (6a) rotatably supported coaxially with an axis Z;
an annular magnetic pole row (4) supported in parallel to a plane H by said rotary shaft (6a); and
a rectangular wave coil (5) corresponding to a stationary member, said rectangular wave coil being arranged so as to face to said annular magnetic pole row with a distance and in parallel,
the axis Z being an axis in a direction of Z-coordinate and the plane H being orthogonal to the axis Z,
wherein said annular magnetic pole row is structured such that N poles and S poles are alternately arranged at a fixed angular pitch p, and said rectangular wave coil is structured such that radial elements around the axis Z are arranged at the pitch p.

5. A motor using a rectangular wave wire as claimed in claim 4, wherein said rectangular wave coil is structured such that a first phase rectangular wave coil (5A) and a second phase rectangular wave coil (5B) are arranged so as to be shifted by one fourth angular pitch (p/4), is provided with a Hall sensor (18) detecting an angle of rotation of said annular magnetic pole row (4) per one fourth angular pitch (p/4), and is provided with a switch circuit alternately switching an electric current application of the first phase rectangular wave coil (5A) and an electric current application of the second phase rectangular wave coil (5B) on the basis of a detected signal of said Hall sensor.

6. A motor using a rectangular wave wire as claimed in claim 2, wherein a rail-cum-case (10) having an angular C-shaped cross section, and having a shape schematically similar to a curtain rail is provided to the motor, said rectangular wave wire (3) is attached to an inner surface of said rail-cum-case, and said linear magnetic pole row (2) can pass through a space within said rail-cum-case in the direction of the axis X.
